(19) United States
(12) Patent Application Publication
(10) Pub. No.: US 2026/0359269 A1
(43) Pub. Date: Nov. 12, 2026

(54) Cloud-native global file system with parallel upload via many-to-one carry through

(71) Applicant: Nasuni Corporation, Boston, MA (US)

(72) Inventor: Daphne M. Shaw, Newton, MA (US)

(21) Appl. No.: 19/200,929

(22) Filed: May 7, 2025

(51) Int. Cl. G06F 16/182; H04L 67/1097

(52) U.S. Cl. CPC G06F 16/1844; H04L 67/1097

(57) ABSTRACT

A method of zero-copy multipart upload provided by a service that pushes objects to a cloud-based object store. Responsive to receipt of individual pieces of a composite file, the service pushes the pieces to the store. An individual file object has an associated file manifest pointing to a chunk. Responsive to receipt of a command to merge the individual pieces back into the composite file, a new file manifest referencing the chunks corresponding to the individual pieces is generated. The new manifest will point to an instantiation of the composite file to be created in the object store. Upon receipt of the new file manifest in the object store, and using a carry through semantic implemented by the service, a multipart upload is then completed. In particular, and upon receipt of the new file manifest, the chunks associated with the individual file objects are joined to synthesize the composite file.

### BACKGROUND

This application relates generally to data storage.

It is known to provide a cloud-native global file system that is used to provide primary file storage for enterprise data. In this approach, edge appliances (or “filers”) typically located on-premises securely transmit all files, file versions and metadata to a preferred private or public cloud object store, while locally caching only active files. The appliances are stateless, and multiple appliances can mount the same volume in the cloud. As files are written locally, an authoritative copy of every file and metadata (inodes) are stored in the cloud. The system provides a single, unified namespace for all primary file data that is not bound by local hardware or network performance constraints. The above-described approach to enterprise file services also has been extended to provide multiple-site/multiple-filer access to the same namespace, thereby enabling participating users with the ability to collaborate on documents across multiple filers/sites. A system of this type is available commercially from Nasuni® Corporation of Boston, Massachusetts.

Multipart upload is a general storage term for uploading a single object to a data store, e.g., by writing the overall object via several smaller pieces and later joining those pieces together on demand. It has various benefits, including performance, as a writer can send as many streams of data as an outbound bandwidth can accommodate. For example, if a process is capable of writing 10 Mbit/s per stream, but an upstream network connection can handle ten such streams (e.g., a 100 Mbit/s connection), the process can write data at 100 Mbit/s by writing the data in ten (10) parts in parallel. Multipart upload also facilitates faster recovery after a failure, e.g., is a process is writing a 50 MB file in five equal parts and one of those parts fails to transfer, the process only has to retransmit that single 10 MB part rather than the entire 50 MB file. POSIX (Portable Operating System Interface)-based filesystems inherently allow for multipart uploads via a simple mechanism of opening a file multiple times and seeking to a different location within the file for each open before writing each part, or by using write primitives such as pwrite( ). Multipart upload, however, is a much more difficult challenge for object storage systems like Amazon® S3® and Microsoft® Azure®, although these cloud providers do provide the capability.

In the context of a cloud-native global file system such as described above, there remains a need enterprise customers to be able to upload individual parts of a file to any edge appliance in that system that is sharing a volume in question, and similarly send a final “merge these parts” command to any of these edge appliances.

### SUMMARY

A method of zero-copy multipart upload is provided by a service that pushes objects to a cloud-based object store. In the method, and responsive to receipt of individual pieces of a composite file, the service pushes the individual pieces of the composite file, as individual file objects, to the cloud-based object store. An individual file object pushed has an associated file manifest pointing to a chunk. In response to receipt of a command to merge the individual pieces back into the composite file (in particular, to complete a multipart upload), a new file manifest is generated. The new file manifest references the chunks corresponding to the individual pieces, and it is to configured to point to an instantiation of the composite file to be created in the cloud-based object store. The new file manifest is forwarded to the cloud-based object store. Upon receipt of the new file manifest there, and using a carry through semantic (which provides that a given chunk pushed to and stored in the cloud-based object store is configured to be referenced by two or more file manifests without requiring storage of multiple copies of the given chunk) implemented by the service, the multipart upload is then completed as follows. In particular, and upon receipt of the new file manifest, the chunks associated with the individual file objects are joined to synthesize the composite file as referenced by the new file manifest. Upon receipt of an indication that the new file manifest is referenced in the cloud-based object store, the former manifests associated with the individual file objects are caused to be deleted from the cloud-based object store.

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF DRAWINGS

For a more complete understanding of the present invention and the advantages thereof, reference is now made to the following descriptions taken in conjunction with the accompanying drawings, in which:

FIG. 1 is a block diagram illustrating how a known versioned file system interfaces a local file system to an object-based data store;

FIG. 2 is a block diagram of a representative implementation of a portion of the interface shown in FIG. 1;

FIG. 3 is a more detailed implementation of the interface where there are a number of local file systems of different types;

FIG. 4 illustrates the interface implemented as an appliance within a local processing environment;

FIG. 5 depicts a versioned file system that implements global locking;

FIG. 6 depicts a process flow for a parallel upload technique; and

FIG. 7 depicts how the cloud-native global file system receives a file and, in response, stores a file manifest and an associated file chunk in a cloud object store corresponding to that file;

FIG. 8 depicts how the cloud-native global file system uses a “carry through” function to allow a same data chunk to be used in more than one place; and

FIG. 9 depicts how the system leverages the carry through function to provide a zero-copy multipart upload solution of this disclosure.

### DETAILED DESCRIPTION

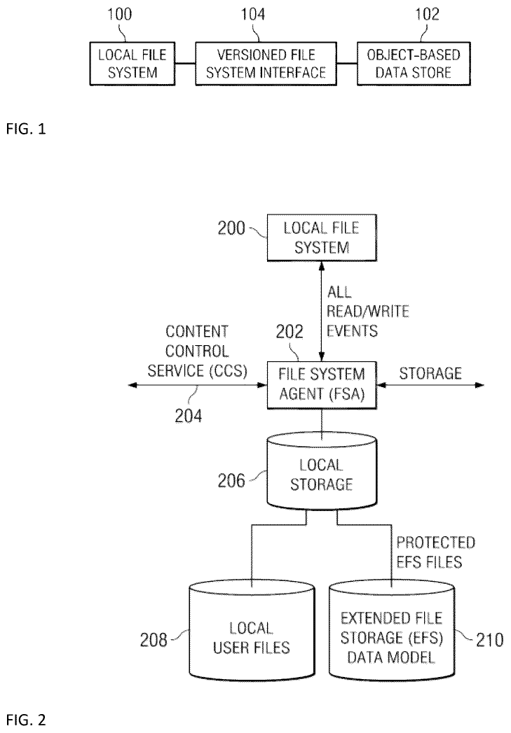

FIG. 1 illustrates a local file system 100 and an object-based data store 102.

Although not meant to be limiting, preferably the object-based data store 102 is a “write-once” store and may comprise a “cloud” of one or more storage service providers. An interface 104 (or “filer”) provides for a “versioned file system” that only requires write-once behavior from the object-based data store 102 to preserve substantially its “complete” state at any point-in-time. As used herein, the phrase “point-in-time” should be broadly construed, and it typically refers to periodic “snapshots” of the local file system (e.g., once every “n” minutes). The value of “n” and the time unit may be varied as desired. The interface 104 provides for a file system that has complete data integrity to the cloud without requiring global locks. In particular, this solution circumvents the problem of a lack of reliable atomic object replacement in cloud-based object repositories. The interface 104 is not limited for use with a particular type of back-end data store. When the interface is positioned in “front” of a data store, the interface has the effect of turning whatever is behind it into a “versioned file system” (“VFS”). The VFS is a construct that is distinct from the interface itself, and the VFS continues to exist irrespective of the state or status of the interface (from which it may have been generated). Moreover, the VFS is self-describing, and it can be accessed and managed separately from the back-end data store, or as a component of that data store. Thus, the VFS (comprising a set of structured data representations) is location-independent. In one embodiment, the VFS resides within a single storage service provider (SSP) although, as noted above, this is not a limitation. In another embodiment, a first portion of the VFS resides in a first SSP, while a second portion resides in a second SSP. Generalizing, any given VFS portion may reside in any given data store (regardless of type), and multiple VFS portions may reside across multiple data store(s). The VFS may reside in an “internal” storage cloud (i.e. a storage system internal to an enterprise), an external storage cloud, or some combination thereof.

The interface 104 may be implemented as a machine. A representative implementation is the Nasuni® Filer, available from Nasuni® Corporation of Boston, Massachusetts. Thus, for example, typically the interface 104 is a rack-mounted server appliance comprising hardware and software. The hardware typically includes one or more processors that execute software in the form of program instructions that are otherwise stored in computer memory to comprise a “special purpose” machine for carrying out the functionality described herein. Alternatively, the interface is implemented as a virtual machine or appliance (e.g., via VMware®, or the like), as software executing in a server, or as software executing on the native hardware resources of the local file system. The interface 104 serves to transform the data representing the local file system (a physical construct) into another form, namely, a versioned file system comprising a series of structured data representations that are useful to reconstruct the local file system to any point-in-time. A representative VFS is the Nasuni Unity File System (UniFS™). Although not meant to be limiting, preferably each structured data representation is an XML document (or document fragment). As is well-known, extensible markup language (XML) facilitates the exchange of information in a tree structure. An XML document typically contains a single root element (or a root element that points to one or more other root elements). Each element has a name, a set of attributes, and a value consisting of character data, and a set of child elements. The interpretation of the information conveyed in an element is derived by evaluating its name, attributes, value and position in the document.

The interface 104 generates and exports to the write-once data store a series of structured data representations (e.g., XML documents) that together comprise the versioned file system. The data representations are stored in the data store. Preferably, the XML representations are encrypted before export to the data store. The transport may be performed using known techniques. In particular, REST (Representational State Transfer) is a lightweight XML-based protocol commonly used for exchanging structured data and type information on the Web. Another such protocol is Simple Object Access Protocol (SOAP). Using REST, SOAP, or some combination thereof, XML-based messages are exchanged over a computer network, normally using HTTP (Hypertext Transfer Protocol) or the like. Transport layer security mechanisms, such as HTTP over TLS (Transport Layer Security), may be used to secure messages between two adjacent nodes. An XML document and/or a given element or object therein is addressable via a Uniform Resource Identifier (URI). Familiarity with these technologies and standards is presumed.

FIG. 2 is a block diagram of a representative implementation of how the interface captures all (or given) read/write events from a local file system 200. In this example implementation, the interface comprises a file system agent 202 that is positioned within a data path between a local file system 200 and its local storage 206. The file system agent 202 has the capability of “seeing” all (or some configurable set of) read/write events output from the local file system. The interface also comprises a content control service (CCS) 204 as will be described in more detail below. The content control service is used to control the behavior of the file system agent. The object-based data store is represented by the arrows directed to “storage” which, as noted above, typically comprises any back-end data store including, without limitation, one or more storage service providers. The local file system stores local user files (the data) in their native form in cache 208. Reference numeral 210 represents that portion of the cache that stores pieces of metadata (the structured data representations, as will be described) that are exported to the back-end data store (e.g., the cloud).

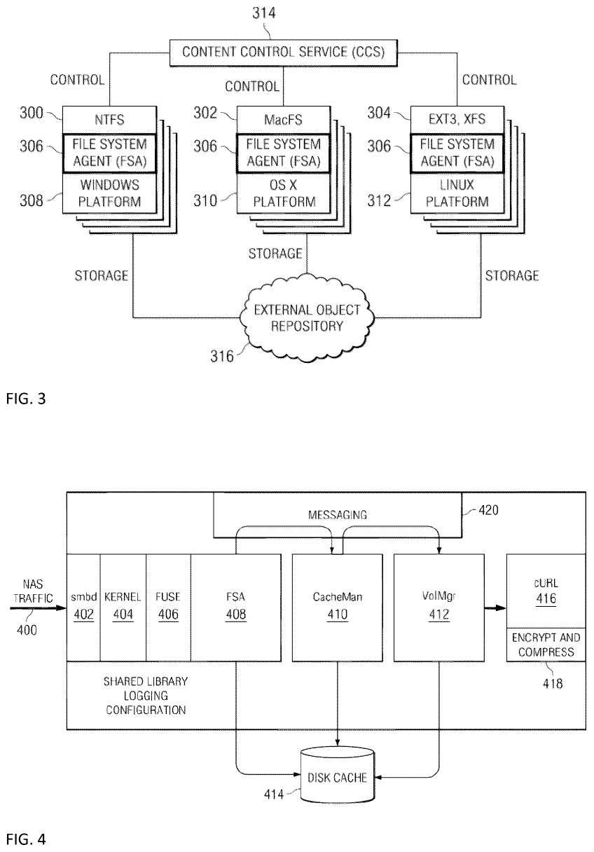

FIG. 3 is a block diagram illustrating how the interface may be used with different types of local file system architectures. In particular, FIG. 3 shows the CCS (in this drawing a Web-based portal) controlling three (3) FSA instances. Once again, these examples are merely representative and they should not be taken to limit the invention. In this example, the file system agent 306 is used with three (3) different local file systems: NTFS 300 executing on a Windows operating system platform 308, MacFS (also referred to as “HFS+” (HFSPlus)) 302 executing on an OS X operating system platform 310, and EXT3 or XFS 304 executing on a Linux operating system platform 312. These local file systems may be exported (e.g., via CIFS, AFP, NFS or the like) to create a NAS system based on VFS. Conventional hardware, or a virtual machine approach, may be used in these implementations, although this is not a limitation. As indicated in FIG. 3, each platform may be controlled from a single CCS instance 314, and one or more external storage service providers may be used as an external object repository 316. As noted above, there is no requirement that multiple SSPs be used, or that the data store be provided using an SSP.

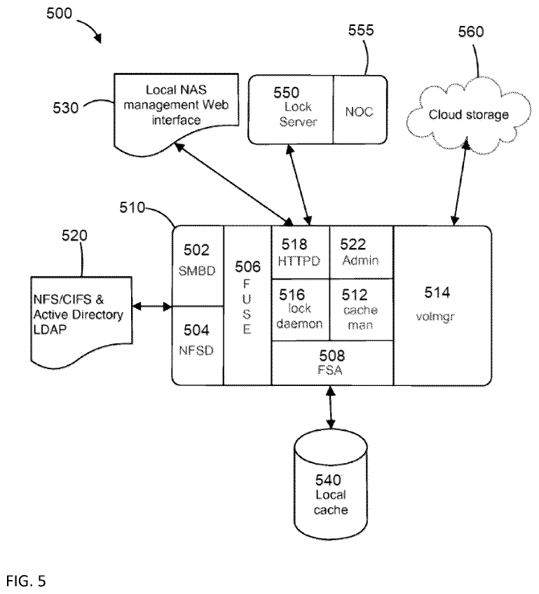

FIG. 4 illustrates the interface implemented as an appliance within a local processing environment. In this embodiment, the local file system traffic 400 is received over Ethernet and represented by the arrow identified as “NAS traffic.” That traffic is provided to smbd layer 402, which is a SAMBA file server daemon that provides CIFS (Windows-based) file sharing services to clients. The layer 402 is managed by the operating system kernel 404 is the usual manner. In this embodiment, the local file system is represented (in this example) by the FUSE kernel module 406 (which is part of the Linux kernel distribution). Components 400, 402 and 404 are not required to be part of the appliance. The file transfer agent 408 of the interface is associated with the FUSE module 406 as shown to intercept the read/write events as described above. The CCS (as described above) is implemented by a pair of modules (which may be a single module), namely, a cache manager 410, and a volume manager 412. Although not shown in detail, preferably there is one file transfer agent instance 408 for each volume of the local file system. The cache manager 410 is responsible for management of “chunks” with respect to a local disk cache 414. This enables the interface described herein to maintain a local cache of the data structures (the structured data representations) that comprise the versioned file system. The volume manager 412 maps the root of the FSA data to the cloud (as will be described below), and it further understands the one or more policies of the cloud storage service providers. The volume manager also provides the application programming interface (API) to these one or more providers and communicates the structured data representations (that comprise the versioned file system) through a transport mechanism 416 such as cURL. cURL is a library and command line tool for transferring files with URL syntax that supports various protocols such as FTP, FTPS, HTTP, HTTPS, SCP, SFTP, TFTP, TELNET, DICT, LDAP, LDAPS and FILE. cURL also supports SSL certificates, HTTP POST, HTTP PUT, FTP uploading, HTTP form based upload, proxies, cookies, user +password authentication, file transfer resume, proxy tunneling, and the like. The structured data representations preferably are encrypted and compressed prior to transport by the transformation module 418. The module 418 may provide one or more other data transformation services, such as duplicate elimination. The encryption, compression, duplicate elimination and the like, or any one of such functions, are optional. A messaging layer 420 (e.g., local socket-based IPC) may be used to pass messages between the file system agent instances, the cache manager and the volume manager. Any other type of message transport may be used as well.

The interface shown in FIG. 4 may be implemented as a standalone system, or as a managed service. In the latter case, the system executes in an end user (local file system) environment. A managed service provider provides the system (and the versioned file system service), preferably on a fee or subscription basis, and the data store (the cloud) typically is provided by one or more third party service providers. The versioned file system may have its own associated object-based data store, but this is not a requirement, as its main operation is to generate and manage the structured data representations that comprise the versioned file system. The cloud preferably is used just to store the structured data representations, preferably in a write-once manner, although the “versioned file system” as described herein may be used with any back-end data store.

As described above, the file system agent 408 is capable of completely recovering from the cloud (or other store) the state of the native file system and providing immediate file system access (once FSA metadata is recovered). The FSA can also recover to any point-in-time for the whole file system, a directory and all its contents, a single file, or a piece of a file. These and other advantages are provided by the “versioned file system” of this disclosure, as it now described in more detail below.

For more details concerning the filer as described above, the disclosure of U.S. Pat. No. 9,575,841 is hereby incorporated by reference.

FIG. 5 is a block diagram that illustrates a system 500 for managing a versioned file system (as described above) that also includes the capability of global locking. The system 500 includes an interface 510 in communication with local traffic 520, a web-based portal 530, a local cache 540, a lock server 550, and cloud storage 560. The interface 510 includes a SMBD layer 502, a NFSD layer 504, a FUSE module 506, a FSA 508, a cache manager 512, a volume manager 514, a lock daemon 516, a transport layer 518, and an administrative module 522. In some embodiments, the interface 510 is the same as the interface described with respect to FIG. 4 but with the addition of the lock daemon 516.

SMB/CIFS lock requests are intercepted by SMBD layer 502, which is a SAMBA file server daemon. An optional Virtual File System (VFS) module can extend the SAMBA server daemon to send the local lock information to the FSA 508. FSA 508 then communicates with FUSE 506 to coordinate the FUSE file descriptors (pointers) with the ioctl information to determine a path for the given file(s) associated with the lock request. Assuming a path is enabled for global locking, FSA 508 sends the lock and path to the lock daemon 516, which handles the lock request as described below. If a path is not enabled for global locking, the lock request stays within the SAMBA server as it did previously (e.g., conflict management, etc. as described above) and it is not sent to the lock daemon 516.

NFS lock requests are passed through the NFSD layer 504 to FUSE 506. Assuming a path prefix is enabled for global locking, FSA 508 communicates with the lock daemon 516 to handle the lock request using a common protocol, as described above. If the path prefix is not enabled for global locking, FSA 508 handles the lock request as it did previously (e.g., conflict management, etc. as described above) and the lock request is not sent to the lock daemon 516.

The lock daemon 516 is responsible for local lock management and coordinating with the global lock server. The lock daemon 516 can perform one or more of the following functions: (a) translating the lock format; (b) communicating with the centralized lock server; (c) acquiring locks; (d) lock peeking; (e) lock re-acquiring; (f) lock releasing; and (g) communicating with the filer.

With respect to translating the lock format, the lock daemon 516 can translate the local file lock requests to a common lock format understood by the centralized lock server 550 (described below). Using this approach, the lock server 550 receives a lock request in one format regardless of the underlying network protocol (e.g., SMB/CIFS or NFS). The centralized lock server 550 can be in a network operations center (NOC) 555.

The lock daemon 516 can then communicate with the centralized lock server 550 by making calls to a Centralized Lock API. Through the API, the lock daemon 516 can execute a lock request, an unlock request, and/or a lock break request. A lock request generally requires the transmission of certain information such as the first handle (a unique identifier to the original base object for the file), the requested lock mode, the file path, the protocol of the requester, etc. Additional information such as timestamps and serial number can be included in the lock request. The requested lock mode is the type of access for the lock, such as a shared or exclusive lock, a lock for read, a lock for write, lock for exclusive write, lock for shared write. If the centralized lock server 550 grants the lock request, the lock server 550 then uses information provided in the lock request (e.g., the first handle) to retrieve the latest version of the requested file from cloud storage 560. The centralized lock server 550 transmits the latest version of the requested file to the lock daemon 516, which can store the file in local cache 540.

An unlock request can include the same or similar information as the lock request but with an updated handle name that was generated as a result of modifications to the locked file. A lock break request can be provided by a system administrator to manually unlock a file (e.g., if a user leaves a locked file open overnight, a server goes down, etc.).

Prior to making a new lock request, the lock daemon 516 determines whether a lock already exists in local cache 540 or on the centralized lock server 550. If no lock exists in either of those locations, the lock daemon 516 acquires a new lock through the centralized lock server 550. The new lock can have a lock mode computed using the requested access and share profiles (masks).

Lock peeking can be initiated every time a file is opened for read. In lock peeking, the lock daemon 516 can query whether a lock exists on the file prior to opening the file. If a lock exists, the lock daemon 516 can also determine the associated lock mode to evaluate whether the lock mode permits the user to open the file. The lock daemon 516 retrieves this information from local lock cache 540 if the filer requesting the lock peek already has a write lock on the file. Otherwise, the lock daemon 516 retrieves this information from the centralized lock server 550. Each lock peek request can be cached in the local lock cache 540 for a short time period (e.g., several seconds) to reduce traffic to the central lock server 550 if the lock daemon 516 receives a new lock peek request shortly after the first lock peek request.

For example, another user may have a lock for exclusive write access to the file that does not allow any shared access (i.e., no shared read access). In this example, the lock daemon 516 determines from the lock query that the file cannot be opened due to an existing lock on the file. In another example, the lock mode can allow shared read or write access in which case the lock daemon 516 determines from the lock query that the file can be opened.

During lock peeking, the lock daemon 516 can also retrieve additional information about the file, such as the file handle, handle version, first handle, and lock push version. The file handle is a pointer to the latest version of the file in the cloud. The handle version is a version of the file in the cloud. The first handle provides a unique identifier to the file across versions and renames of the file. The lock push version is the latest version of the file that was sent to the cloud.

The lock deamon 516 can cache locks and unlocks in a local lock cache 540 for release to the centralized lock server 550. If a lock request is made for a file that has a cached unlock request, the lock can be reestablished without having to acquire a new lock from the centralized lock server 550. In such a situation, the unlock request is cancelled. This caching can reduce load on the lock server 550 and improve response time. In general, the unlock requests are cached for a certain period of time prior to release to the lock server 550 to allow for such lock reestablishment.

As discussed above, the lock request includes information on the protocol (e.g., SMB/CIFS or NFS) of the requester and the lock mode. The lock server 550 receives this information and can determine, based on any existing lock(s) on the requested file, whether the lock server 550 can issue multiple locks on the same file. The lock server 550 can evaluate the protocol used by the requester of the existing lock and the associated access/share permissions of that lock and determine whether protocol used with the new lock requester is compatible.

In addition, the lock daemon 516 handles lock releases. In some embodiments, the lock daemon 516 does not immediately send the lock release to the lock server 550. This time delay can reduce load on the centralized lock server 550 because files are frequently locked and unlocked in rapid succession, as discussed above. Before a lock is released, if the file was changed, the current data is sent to cloud storage 560 (e.g., Amazon S3, Microsoft Azure, or other public or private clouds) so the most recent data is available to the next locker.

Finally, the lock daemon 516 can communicate with the FSA 508. The lock daemon 516 can receive lock requests and/or lock peek requests from FSA 508, which the lock daemon 516 translates into a common protocol for transmission to the centralized lock server 550, as discussed above. The lock daemon can also pass the updated handle name to the FSA 508 to perform a file-level snapshot before unlocking a file and/or a file level merge/synchronization before locking a file.

For global locking, it is desirable for the locker to have the most recent version of the file associated with the lock request (and lock grant). To accomplish this, the cache manager 512 can be configured to snapshot a single file (e.g., the file associated with the lock request) without triggering a copy-on-write (COW) event (which would cause a version update, as discussed above) and without affecting other snapshot operations. After a single file snapshot, the cache manager 512 can mark all parent directories of the file as changed or “dirty.” In addition, the fault manager algorithm can be configured to fault a single file based on requests from the FSA 508.

The merge/push algorithm can be modified to provide for merging single files. Before the locked file is pushed to the local cache 540, the NOC 555 assigns a unique lock version (e.g., 64 bit) to the file. The lock version can be used by FSA 508 to determine whether a locked file or its metadata is dirty (i.e., changed). The parent directories of the locked file can continue to use the existing write version assigned from the last TOC. Thus, FSA 508 can track two values: lock_write_version and lock_push_version. When a file or directory is dirtied, the lock_write_version is updated. When a file or directory is pushed to local cache 540, the lock_push_version is updated.

As discussed above, the file data from the NOC 555 (or centralized lock server 550) is merged into the local cache 540 before the FSA 508 returns control of the file to the client. To determine if the file data in the NOC 555 is newer than the file data in the cache 540 (e.g., if the lock is retrieved while an unlock request is cached), the FSA checks MAX (lock_write_version, lock_push_version) against the NOC lock version. If the NOC lock version is greater than the lock_write_version and the lock_push_version, the file data (object metadata and data) from the NOC 555 is used to instantiate the object (locked file) in the local cache 540. If the file data in the cache 540 is newer, then the file data from the NOC 555 is discarded. In the circumstance where the NOC 555 indicates that the file is deleted, the delete version is compared to the local cache 540 version in order to apply the delete to the local cache 540.

In addition, the merge/push algorithm can be modified to reconcile the single-file merges of locked files with the snapshot merges of files. Any file that was “fastsynched” through the FSA 508 (i.e., locked) or “fastpushed” to the cloud (i.e., unlocked) is designated as “cloud fastsynced.” When merging an object or file that is considered “cloud dirty” or “cloud fastsynched,” the FSA 508 will update the file if the incoming lock_push_version is greater than MAX (lock_write_version, lock_push_version), as discussed above. If the incoming lock_push_version is less than MAX (lock_write_version, lock_push_version), the cache object is considered newer and the incoming update is discarded by the FSA 508. Also, when a file is missing (deleted) from the pushed version but the file is also locally fastsynched, the file will not be deleted. This merging can occur concurrently or before the global lock on the file is granted.

In addition, if a file has been deleted or renamed, the local cache metadata can record a “delete tombstone” which includes certain information (e.g., parent first handle, lock version, name, etc.). FSA 508 merges a file as new if the file is newer than any delete tombstone contained in the cache for the unique file. This can address the situation in which a file has been fast synchronized before merge. In that case, the incoming cloud dirty file is old compared to the cache and the import is discarded.

To ensure that the unlocked file includes the changes from the latest version, the locked file can only be unlocked when the lock_push_version is greater than or equal to the lock_write_version at which point the FSA 508 sends the lock_push_version back to the NOC 555 (or centralized lock server 550) to store the new version of the file in cloud storage 560.

In some embodiments, the interface 510 snapshots and merges new files at the time of creation. The new file requests can be stored on the lock server 550 with the lock entries. Other users can poll the lock server 550 to determine if new files/objects exist that have not yet been populated to the cloud 560, for example if there are new files/objects in a given directory. After the new files have been created, the locker server 550 can merge the new file requests into the appropriate directories in the cloud 560.

The filers may be anywhere geographically, and no network connectivity between or among the filers is required (provided filers have a connection to the service).

Sharing enables multi-site access to a single shared volume. The data in the volume is 100% available, accessible, secure and immutable. The approach has infinite scalability and eliminates local capacity constraints. The sites (nodes) may comprise a single enterprise environment (such as geographically-distributed offices of a single enterprise division or department), but this is not a requirement, as filers are not required to comprise an integrated enterprise. This enables partners to share the filesystem (and thus particular volumes therein) in the cloud. Using the service provider-supplied interfaces, which are preferably web-based, the permitted users may set up a sharing group and manage it. Using the sharing approach as described, each member of the sharing group in effect “sees” the same volume. Thus, any point-in-time recovery of the shared volume is provided, and full read/write access is enabled from each node in the sharing group.

### Parallel Upload via Many-to-One Carry Through

As has been described, according to this disclosure a cloud-native global file system (such as described above and depicted in FIGS. 1-5) used to provide primary file storage for enterprise data is augmented to provide an additional functionality, referred to herein as multipart (parallel) upload via many-to-one carry through.

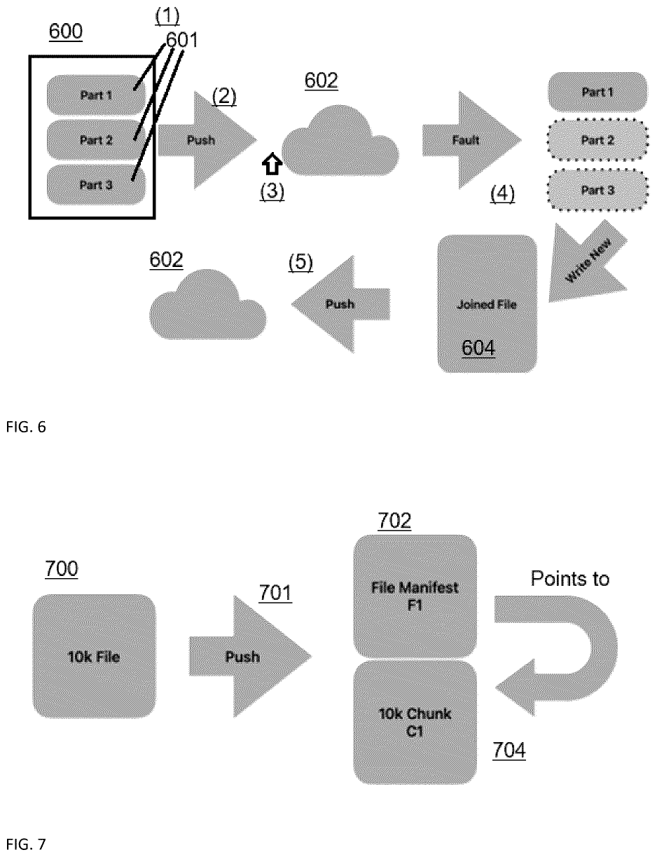

FIG. 6 depicts one possible multipart upload solution, wherein customers write individual parts and then concatenate them together. In this example scenario, the cloud-native global file system is as depicted in FIGS. 1-4, and as described above. In this example, the customer (or more specifically some customer “process”) has a file 600. At step (1), the process write multiple parts 601 (Parts 1-3) and, at step (2) the system pushes the parts 601 to a cloud object store 602 (or “cloud”). From the system perspective, each part is a distinct file, and step (2) pushes the parts to the cloud 602 as regular file objects. At step (3), the customer issues a command to merge the parts. In response, and at step (4), the system reads each part (potentially needing to fault them in), and writes the part into a new, joined, file 604. At step (5), the system pushes the resulting merged file 604 to the cloud 602 to complete the upload. While the above approach provides a workable multipart upload, it is not optimal. It is expensive in terms of bandwidth, as each part traverses the network several times. Moreover, it is also expensive in terms of storage, as writing even a single file requires the system to handle the data multiple times (at best, every byte must be written (as a part), then read (as a part), then written again (as a piece of a file), and then finally pushed to the cloud). Further, the approach is limited in size, as the size of the resultant file 604 is limited by available space in a filer cache, as it is written as a single file. While individual changes can be made to the above-described workflow to address some of these limitations, the following provides a preferred method for multipart upload according to this disclosure.

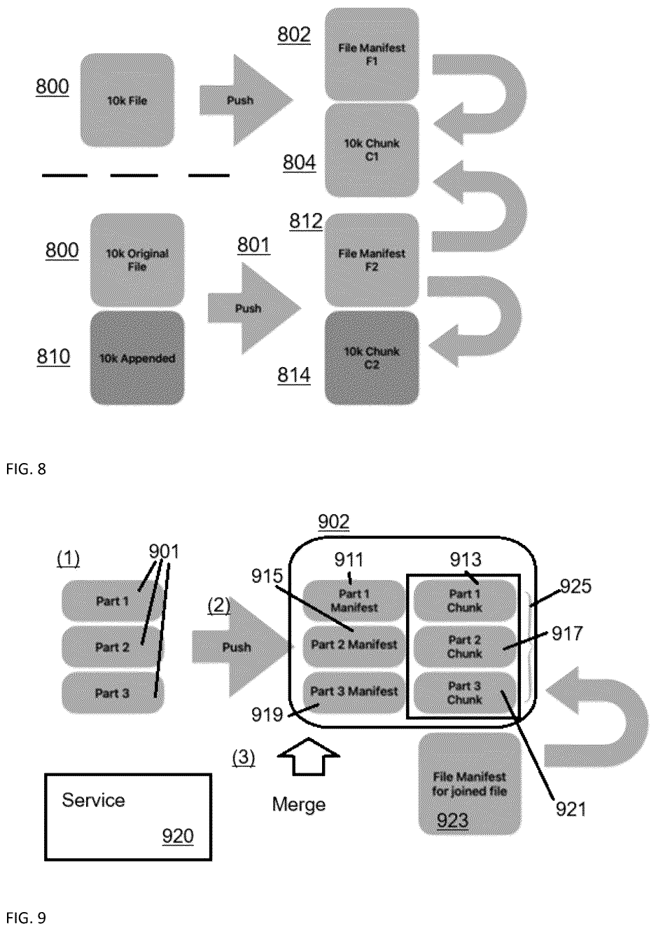

According to this aspect, and rather than treat part assembly as a simple concatenation of data, the system treats part assembly in a different manner, namely, as a variant of a “carry through” semantic for modified files. The notion of “carry through” is a method of data deduplication in the cloud to allow a same data chunk to be used in more than one place. FIG. 7 depicts how carry through works. In this example, when a customer process is writing a single, say, 10K file 700, after pushing 701 to the cloud, the system winds up with a file manifest F1 702 pointing to a single new file chunk C1 704. This basic process is described, for example, in U.S. Pat. No. 11,681,584, the disclosure of which is incorporated herein by reference. Now, and as depicted in FIG. 8, if a second 10K chunk 810 were then appended to the end of this file 800, after pushing 801 to the cloud, the system winds up with a new file manifest, F2812, pointing to two data chunks, namely: the original chunk C1 804, and a new chunk C2 814 carrying the added 10K. As also depicted, the original file manifest F1 802 is still present, and still points to the original chunk C1 804. In other words, this “carry through” scenario is effectively two “files” (referred to as “versions” in the system) in the cloud; but, because the original chunk C1 is referred to twice (by the two file manifests F1 and F2) while only being stored once, the overall space that is taken up in the cloud for the two files can be significantly less than the actual size the two files in question. The storage savings obtained by carry through are even greater as the number of versions of the file existing gets larger.

With the above as background, the following describes how leveraging the system's “carry through” function provides for a zero-copy mulitpart upload solution according to this disclosure. In this solution, which is depicted in FIG. 9, the basic carry through notion is extended to create whole new files that are made up of data chunks from earlier files. As will be seen, this is a zero-copy process because only a manifest needs to be written (as the data itself is already in the cloud). It is thus very fast and efficient.

With reference to FIG. 9, at step (1), and similar to FIG. 6, the customer writes multiple parts 901 (once again Parts 1-3 in this example) and, at step (2) the system (the cloud native global file system service) pushes the parts to the cloud 902 as regular file objects, as before. At step (3), once again the customer issues the command to merge the parts 901. As also depicted, and as a result of these operations, Part 1 has an associated Part 1 manifest 911 pointing to the Part 1 chunk 913 that holds Part 1, Part 2 has an associated Part manifest 915 pointing to the Part 2 chunk 917 that holds Part 2, and Part 3 has an associated Part 3 manifest 919 pointing to the Part 3 chunk 921 that holds Part 3. This is where the operation diverges. In particular, and as depicted in step (4), instead of reading (and potentially faulting) the individual parts back, a component in the system (depicted in FIG. 9 as service 920) instead creates and pushes a new file manifest 923 that incorporates the chunks needed to create the file. Typically, that component is an edge appliance (a filer, as described above) of a set of such appliances (filers) that share a volume in the object store. Upon receipt of the new file manifest 923, the chunks (Part 1, Part 2 and Part 3) are merged into a new merged file 925 (in effect, completing the multipart upload by taking the existing objects and using them to synthesize the new object). At the end of this process, once the new merged file is safely referenced in the cloud (i.e., present in its parent directory, and wherein all directories leading up to that parent directory contain the appropriate child), the individual file manifests of the component parts (Part 1, Part 2, and Part 3) may safely be deleted. The component part chunks are now part of the new, joined, file. Stated another way, it is safe to delete the old component partmanifests once new edge appliances (in the cloud-native global file system) can see this new joined file when walking down from the root directory. According to the workflow herein, the old component part manifests are deleted.

The above-described design has significant advantages. It is much less expensive in terms of bandwidth, as it is a zero-copy solution. Once any data is written to the cloud, it does not need to be reprocessed in any way. It is also much less expensive in terms of storage, as the data is stored a single time in the cloud, even during the state (and time) when both the parts and the final merged file temporarily exist. It is also fast, as creating the multipart file involves just creating a single file manifest (a relatively small object) as it only serves a referencing function and does not need to process any data. Finally, the solution does not have any size limitation because as the individual parts have already been pushed to the cloud (and the new file manifest is only referencing them), the resultant file can be of any size, as no significant space is needed on the edge appliance to generate a file manifest. Further, the notion that the original manifests are only deleted after the final merged file manifest is stored and referenced in the cloud ensures that there is no need to take firewalls into account because is no version gap in chunk visibility and thus no possibility for there to a firewall in that version gap.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be specially constructed for the required purposes, or it may comprise a computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A computer-readable medium having instructions stored thereon to perform the interface functions is tangible.

A given implementation of the disclosed subject matter is software written in a given programming language that runs on a server on an Intel-based hardware platform running an operating system such as Linux. As noted above, the interface may be implemented as well as a virtual machine or appliance, or in any other tangible manner.

While given components of the system have been described separately, one of ordinary skill will appreciate that some of the functions may be combined or shared in given instructions, program sequences, code portions, and the like.

In the preferred approach as described, filers do not communicate directly with one another but, instead, communicate through a hub-and-spoke architecture. Thus, the notification mechanism typically leverages the intermediary (e.g., NMC) for passing the queries and responses, as has been described. In an alternative embodiment, and depending on the underlying architecture, some filer-to-filer communication may be implemented.

Having described the subject matter, what I claim is as follows.

1. A method of zero-copy multipart upload provided by a service that pushes objects to a cloud-based object store, comprising:
responsive to receipt of individual pieces of a composite file, pushing the individual pieces of the composite file, as individual file objects, to the cloud-based object store, wherein an individual file object pushed has an associated file manifest pointing to a chunk;
responsive to receipt of a command to merge the individual pieces back into the composite file, generating a new file manifest referencing the chunks corresponding to the individual pieces, the new file manifest being configured to point to an instantiation of the composite file to be created in the cloud-based object store;
forwarding the new file manifest to the cloud-based object store, wherein, upon receipt of the new file manifest, the chunks associated with the individual file objects are joined to synthesize the composite file as referenced by the new file manifest; and
upon receipt of an indication that the new file manifest is referenced in the cloud-based object store, causing the manifests associated with the individual file objects to be deleted from the cloud-based object store.

2. The method as described in claim 1, further including determining whether the composite file as referenced by the new file manifest is safely referenced in the cloud-based object store.

3. The method as described in claim 2, wherein a determination that the composite file as referenced by the new file manifest is safely referenced determines that the composite file is present in a parent directory, and that all directories leading up to the parent directory are visible.

4. The method as described in claim 1, wherein the individual file objects are joined to synthesize the composite file according to a carry through semantic wherein a given chunk pushed to and stored in the cloud-based object store is configured to be referenced by two or more file manifests without requiring multiple copies of the given chunk.

5. The method as described in claim 4, wherein enforcing the carry through semantic with respect to the new file manifest synthesizes the composite file from the individual file objects.

6. The method as described in claim 1, wherein the new file manifest is generated in an edge appliance coupled to the cloud-based object store via the service.

7. The method as described in claim 1, wherein the cloud-based object store is implemented in a cloud infrastructure.

8. The method as described in claim 7, wherein the service is provided by an entity that is distinct from an operator of the cloud infrastructure.

9. A non-transitory computer-readable medium, having stored thereon computer program instructions to cause a computing system to execute a process, the process providing zero-copy multipart upload to a cloud-based object store, the computer program instructions comprising program code configured to:
in response to receipt of individual pieces of a composite file, push the individual pieces of the composite file, as individual file objects, to the cloud-based object store, wherein an individual file object pushed has an associated file manifest pointing to a chunk;
in response to receipt of a command to merge the individual pieces back into the composite file, generate a new file manifest referencing the chunks corresponding to the individual pieces, the new file manifest being configured to point to an instantiation of the composite file to be created in the cloud-based object store;
forward the new file manifest to the cloud-based object store, wherein, upon receipt of the new file manifest, the chunks associated with the individual file objects are joined to synthesize the composite file as referenced by the new file manifest; and
upon receipt of an indication that the new file manifest is referenced in the cloud-based object store, cause the manifests associated with the individual file objects to be deleted from the cloud-based object store.

10. The non-transitory computer-readable medium as described in claim 9, wherein the program code is further configured to determine whether the composite file as referenced by the new file manifest is safely referenced in the cloud-based object store.

11. The non-transitory computer-readable medium as described in claim 10, wherein a determination that the composite file as referenced by the new file manifest is safely referenced determines that the composite file is present in a parent directory, and that all directories leading up to the parent directory are visible.

12. The non-transitory computer-readable medium as described in claim 9, wherein the individual file objects are joined to synthesize the composite file according to a carry through semantic wherein a given chunk pushed to and stored in the cloud-based object store is configured to be referenced by two or more file manifests without requiring multiple copies of the given chunk.

13. The non-transitory computer-readable medium as described in claim 12, wherein enforcing the carry through semantic with respect to the new file manifest synthesizes the composite file from the individual file objects.

14. The non-transitory computer-readable medium as described in claim 9, wherein the program code configured to generate the new file manifest is located in an edge appliance coupled to the cloud-based object store.

15. A method of zero-copy multipart upload provided by a service that pushes objects to a cloud-based object store, comprising:
pushing a set of files to the cloud-based object store, wherein a file in the set of files comprises a chunk, and a manifest of a first type pointing to that chunk;
pushing a manifest of a second type to the cloud-based object store, the manifest of the second type referencing the chunks in the set of files;
responsive to receipt of the manifest of the second type, joining the chunks into a merged file; and
responsive to a determination that the manifest of the second type is referenced in the cloud-based object store, deleting the manifests of the first type.
